(19) United States
(12) Patent Application Publication
(10) Pub. No.: US 2026/0361791 A1
(43) Pub. Date: Nov. 12, 2026

(54) METHODS AND PRODUCTS FOR ONLINE MONITORING TO PREVENT PREDATORY INTERNET ACTIVITIES

(71) Applicant: University of South Florida, Tampa, FL (US)

(72) Inventors: Tingting Zhang, Tampa, FL (US); Jing Wang, Tampa, FL (US); Guangjing Wang, Tampa, FL (US); Xiaoming Lin, Tampa, FL (US)

(21) Appl. No.: 19/672,214

(22) Filed: May 8, 2026

Related U.S. Application Data
(60) Provisional application No. 63/802,127, filed on May 8, 2025.

(51) Int. Cl. H04L 67/1396; G06F 40/30; H04L 51/21

(52) U.S. Cl. CPC H04L 67/1396; G06F 40/30; H04L 51/21

(57) ABSTRACT

A monitoring computer installed on a network can identify a plurality of communications among participating computers on the network. The monitoring computer implements a heterogeneous temporal interaction graph (HTIG) representing the communications among diverse computer applications on the network and assesses risk of illicit behavior associated with respective communications. Applying the heterogeneous temporal interaction graph (HTIG) to a trained heterogeneous temporal graph transformer (HTGT) permits aggregating contextual information about the diverse computer applications and the respective communications to assign a risk score to communication patterns and implement follow up steps including crisis alerts or educational activities.

### CROSS-REFERENCE TO RELATED APPLICATIONS

This application claims priority to and the benefit of U.S. provisional patent application No. 63/802,127, filed on May 8, 2025, and titled “AI-Driven Solution to Safeguard Teenagers from Online Predatory Activities,” the disclosure of which is hereby incorporated by reference herein in its entirety.

### STATEMENT OF GOVERNMENT RIGHTS

None.

### FIELD OF THE INVENTION

This disclosure includes methods, systems and products that assist in preventing predatory activities online that expose internet users to illegal or abusive content that may include inappropriate personal communications. More particularly, this disclosure includes a privacy-preserving, risk-tiered, real-time behavioral detection and intervention system for online safety, particularly for minors. The disclosure highlights edge artificial intelligence (AI) processing, encrypted reporting, guardian alerts, and adaptive educational interventions as core elements

### BACKGROUND

Even with the advent of numerous efforts to protect children on the Internet, parents and guardians of minors continue to seek proactive solutions to safeguard their families across digital platforms. This is particularly true for parents and guardians of teenagers or other children who have access to online networks. Parents, guardians, teachers and other adults charged with responsibilities for minors seek solutions to protect children through real-time behavioral detection, proactive education, and actionable safety interventions across multiple digital platforms.

Key pain points faced by the public include an inability to detect nuanced grooming behaviors directed to minors that develop over time, rather than through overtly explicit content and fragmentation across devices and platforms, leaving critical vulnerabilities in current protection strategies. Online activities also lack real-time educational interventions that teach users how to recognize, resist, and report grooming behaviors as they happen, rather than after incidents have occurred. Threats to computer users are not limited to traditional communication tools such as email or chat functions, but more threats are quickly arising on non-traditional platforms like gaming consoles, emerging social media applications, and wearable devices where traditional monitoring tools offer limited coverage. These and other aspects of modern communications present obstacles that merit the use of more sophisticated monitoring tools to combat predatory behavior.

### SUMMARY

Other aspects and features according to the example embodiments of the disclosed technology will become apparent to those of ordinary skill in the art, upon reviewing the following disclosure.

Embodiments of this disclosure include a computer-implemented method of monitoring online activities and the method may include placing a monitoring computer in data communication on a network, the monitoring computer having a processor connected to computer memory storing risk monitoring software for use on the network; using the monitoring computer to identify a plurality of communications among participating computers on the network, wherein the participating computers communicate by implementing diverse computer applications; using the monitoring computer, constructing and storing a heterogeneous temporal interaction graph (HTIG) representing the communications among the diverse computer applications on the network; assessing risk associated with respective communications among the diverse computer applications by applying the heterogeneous temporal interaction graph (HTIG) to a trained heterogeneous temporal graph transformer (HTGT); and using the trained HTGT, aggregating contextual information about the diverse computer applications and the respective communications to assign a risk score to communication patterns corresponding to respective diverse computer applications.

### BRIEF DESCRIPTION OF THE DRAWINGS

Reference will now be made to the accompanying drawings, which are not necessarily drawn to scale. The patent or application file contains at least one drawing executed in color. Copies of this patent or patent application publication with color drawing(s) will be provided by the Office upon request and payment of the necessary fee.

FIG. 1 is a flow chart showing steps of an example method implementing aspects of the present disclosure in accordance with one or more embodiments.

FIG. 2 is a computer architecture diagram showing a computing system capable of implementing aspects of the present disclosure in accordance with one or more embodiments.

FIG. 3 is a PRIOR ART flow diagram showing operations of a heterogeneous temporal graphical transformer (HTGT) implementation in accordance with an embodiment of the present disclosure.

FIG. 4 is another flow chart representing steps of the method of this disclosure in use with the HTGT of FIG. 3.

FIG. 5 is an overview schematic of how systems, methods and products of this disclosure may be utilized in a privacy-preserving, monitoring, and alert system with crisis support and educational options.

FIG. 6 is a step by step analysis of how an HTGT of this disclosure may be set up to provide context driven decision making in regard to risks online for any given network user and allow for personalized communications and educational steps accordingly.

FIG. 7 is an illustration of a one-stop crisis response hub that may be implemented according to the risk analysis of this disclosure.

### DETAILED DESCRIPTION

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

As discussed herein, a “subject” (or “patient”) may be any applicable human, animal, or other organism, living or dead, or other biological or molecular structure or chemical environment, and may relate to particular components of the subject, for instance specific organs, tissues, or fluids of a subject, may be in a particular location of the subject, referred to herein as an “area of interest” or a “region of interest.”

A detailed description of aspects of the disclosed technology, in accordance with various example embodiments, will now be provided with reference to the accompanying drawings. The drawings form a part hereof and show, by way of illustration, specific embodiments and examples. In referring to the drawings, like numerals represent like elements throughout the several figures.

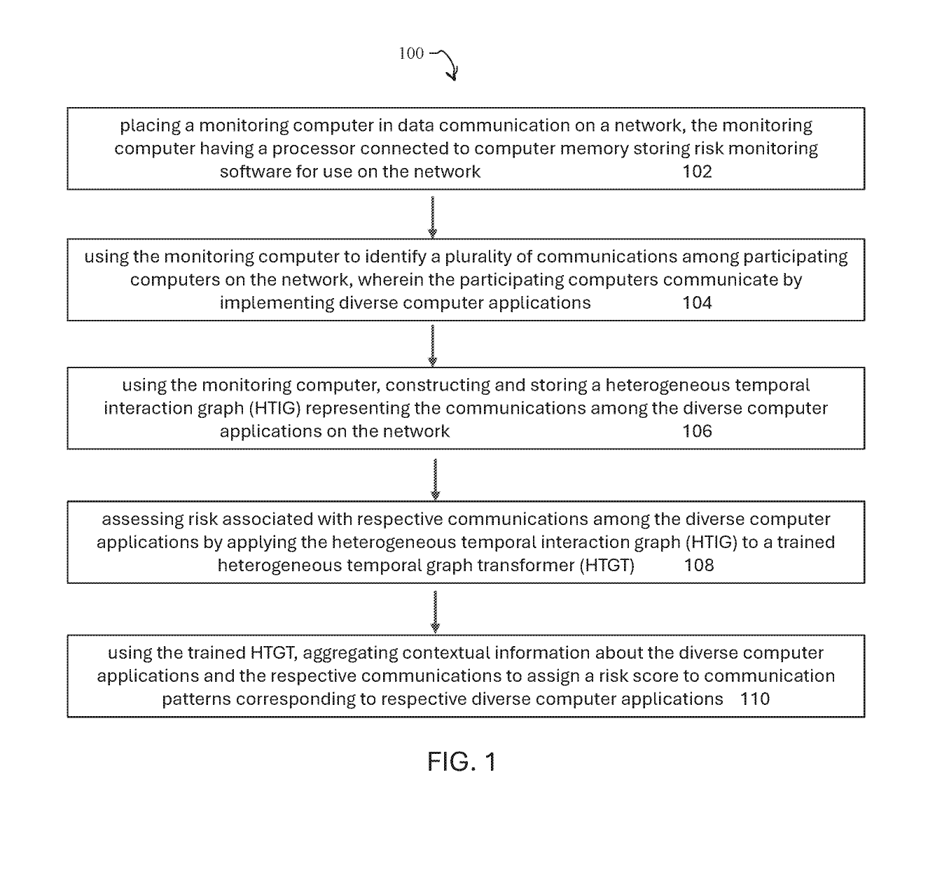

FIG. 1 is an overview flow chart of one method of providing a real-time behavioral detection and intervention system for individuals communicating over the Internet or on other communications networks. The software implemented in the method and systems disclosed herein protects individuals’ privacy while still providing a tiered structure that allows for escalating risks to be addressed quickly and appropriately. The computer implemented method 100 of FIG. 1 includes steps for monitoring online activities by placing a monitoring computer in data communication on a network 102, the monitoring computer having a processor connected to computer memory storing risk monitoring software for use on the network; using the monitoring computer to identify a plurality of communications among participating computers on the network 104, wherein the participating computers communicate by implementing diverse computer applications; using the monitoring computer, constructing and storing a heterogeneous temporal interaction graph (HTIG) 106 representing the communications among the diverse computer applications on the network; assessing risk associated with respective communications among the diverse computer applications 108 by applying the heterogeneous temporal interaction graph (HTIG) to a trained heterogeneous temporal graph transformer (HTGT); and using the trained HTGT, aggregating contextual information 110 about the diverse computer applications and the respective communications to assign a risk score to communication patterns corresponding to respective diverse computer applications.

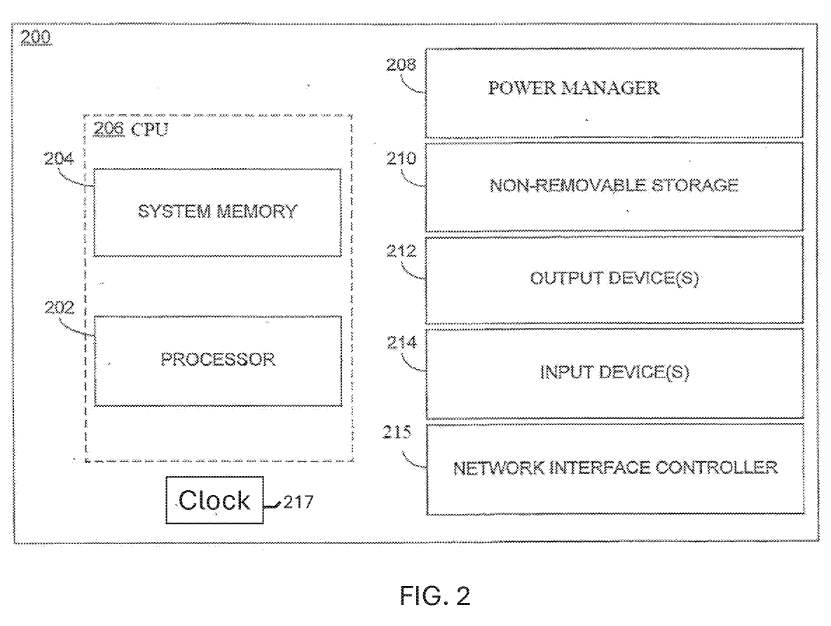

FIG. 2 is a computer architecture diagram showing a computing system capable of implementing aspects of the present disclosure in accordance with one or more embodiments described herein. A computer 200 may be configured to perform one or more specific steps of a method and/or specific functions for a system. The computer may be configured to perform one or more functions associated with embodiments illustrated in one or more of the figures herein. For example, the computer 200 may be configured to perform aspects described herein for implementing the artificial intelligence steps shown in the figures in the context of monitoring network communications. It should be appreciated that the computer 200 may be implemented within a single computing device or a computing system formed with multiple connected computing devices. The computer 200 may be configured to perform various distributed computing tasks, in which processing and/or storage resources may be distributed among the multiple devices. The data acquisition and display computer and/or operator console of the system shown in FIG. 2, and the controller or CPU 206 and may include one or more components of the computer 200.

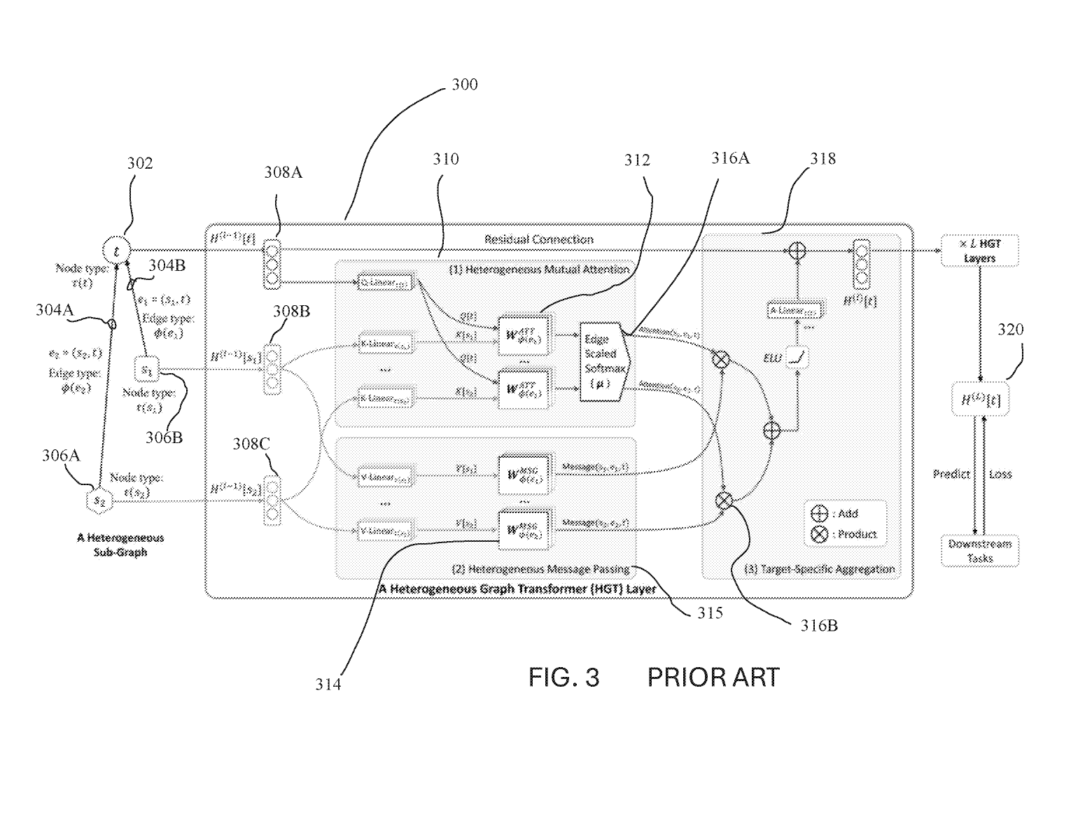

As shown, the computer 200 includes a processing unit 206 (“CPU”), a system memory 204 coupled to at least one processor 202. The computer 200 further includes a mass storage device storing program modules or components described herein. The program modules or components may be operable to perform functions associated with one or more embodiments described herein. For example, when executed, the program modules can cause one or more computers to perform functions described herein for implementing artificial intelligence shown, by example, in FIG. 3, and performed by the method shown in FIG. 1. The program modules may include computer programs that monitor network communications between nodes of a network.

The example computer of this disclosure may also include a power management section 208, non-removable storage 210, input hardware 214 to receive data from other devices connected on a network, output hardware 212 to send communications and/or any kind of data, alerts, or content to other devices.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, or other optical storage, magnetic cassettes, magnetic tape, magnetic disk storage or other magnetic storage devices, or any other medium which can be used to store the desired information and which can be accessed by the computer 200. “Computer storage media”, “computer-readable storage medium” or “computer-readable storage media” as described herein do not include transitory signals.

According to various embodiments, the computer 200 may operate in a networked environment using connections to other local or remote computers through a network via a network interface controller 215. The network interface controller 215 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 200 may also include input/output hardware 214/212 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 200. The input/output hardware may be configured to manage output to one or more display devices for displaying visually representations of data, such as display monitors/screens that are integral with other components of the computer 200 or are remote displays.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state, or may include rotating media storing magnetically-encoded information.

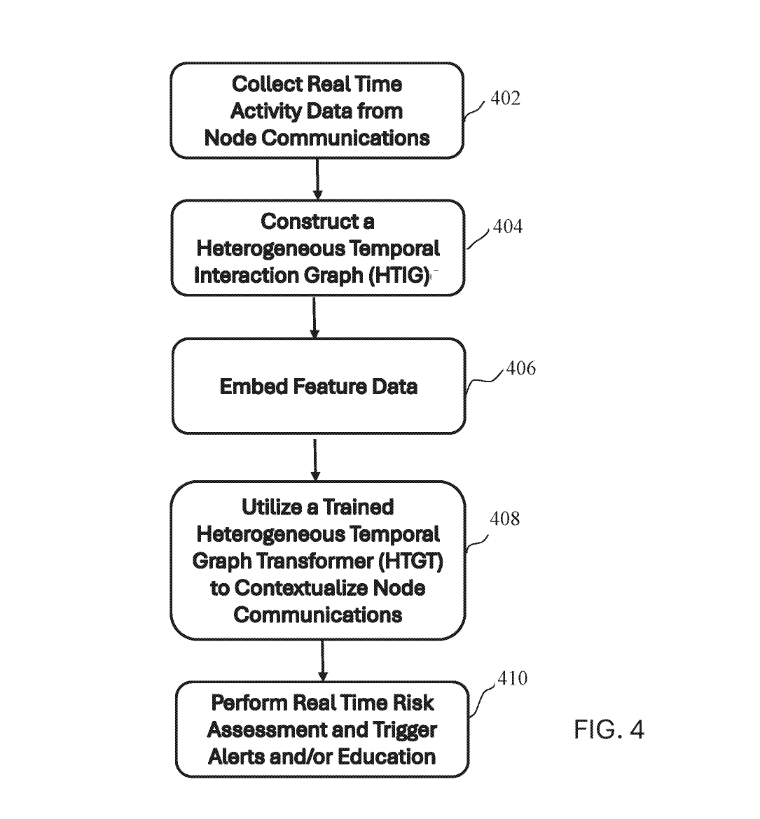

Embodiments of this disclosure set forth AI-powered systems, including but not limited to the architecture of FIG. 3, designed to proactively protect individuals, such as but not limited to teenagers or younger children, from online predatory behavior. As shown in FIGS. 4 – 7, the system integrates real-time behavioral monitoring, adaptive educational intervention, and multi-tiered crisis support. It ensures compliance with privacy standards while offering intelligent alerts, personalized learning pathways, and comprehensive emergency responses tailored for adolescent users.

Devices and hardware used for personal communications have expanded with greater degrees of sophistication in terms of speed, availability, and prevalence among minor children, particularly teenagers. Unfortunately, these advances in communications technology have also brought forth new ways that users can mask their true identities and motives or infiltrate vulnerable communities with illicit activity.

Fast-paced, state of the art advances in communications hardware and software require equally powerful tools to combat illegal or illicit activity on communications networks. One proposed solution to protect individuals from online malfeasance is to combat the problem with artificial intelligence (AI). Accordingly, this disclosure includes an AI-powered system designed to protect children (e.g., teenagers) from online predatory activities. It integrates real-time behavior analysis, machine learning-based detection of grooming and coercive communication patterns, cross-platform monitoring (social media, messaging apps, gaming platforms), adaptive educational interventions for teenagers, and instant guardian alerts. The solution is privacy-centric, offering edge AI processing and encrypted reporting to safeguard users’ data.

One non-limiting kind of AI that can be used to meet the goals of this disclosure is shown in a heterogeneous temporal graphical transformer (HTGT) illustrated in FIG. 3, which has been provided from Reference [1] and annotated for use herein. An HTGT is a powerful network tool that allows for contextualizing the environment at and around nodes of a graphical network, even when the nodes of the graphical networks represent different types of network participants. The HTGT of FIG. 3, as explained in detail in FIG. 1 allows for diverse kinds of communications and different types of participants on a communications network to be accounted for in terms of online safety. This disclosure incorporates by reference the article entitled Heterogeneous Graph Transformer (Hu, Wang, Dong, and Sun 2020) [1]. FIG. 3 of this disclosure is a prior art figure taken from the article reference [1] and shown as FIG. 2 therein. In terms of using an HTGT to monitor a communications network, this disclosure uses outlined steps of FIG. 4 by which methods, systems and computer program products, as claimed herein, can provide the real time analysis of network communications to identify dangerous and/or escalating behavior. As laid out in FIG. 4, the steps of this disclosure generally include collecting real time activity data from node communications 402; constructing a Heterogeneous Temporal Interaction Graph (HTIG) 404 that models users, computers, and/or diverse types of computer software applications as “nodes” communicating across connections referred to in the industry as “edges” of a graphical network in a interaction graph. The method continues by embedding, into neural network vectors, selected feature data 406 that can be gleaned from the communications that network participants (modeled as “nodes” in a graph) share across communication network connections (modeled as “edges” in the graph). The overall method of this disclosure includes using a trained HTGT 408 to contextualize network communications at and around each node of the HTIG (i.e., the interaction graph) in real time. One non-limiting output of the HTGT may be data that is evaluated by the trained HTGT or other software to determine next steps, including real time risk assessment 410 that may be used to trigger alerts described below or provide additional education steps for users.

Before an HTGT may be used in real time scenarios, it must be trained 408. Training may include utilizing transformer-based self-attention mechanisms that capture temporal dependencies and inter-type interactions. Time encoding layers that represent the timestamp and intervals of interactions. Multi-head attention across node and edge types to model heterogeneous semantics. In other words, the HTGT of FIG. 3 herein learns patterns across diverse node types (e.g., users vs. content) and time-evolving relationships. In this way the HTGT is useful to capture risk escalation (e.g., a shift from benign conversation to manipulative grooming behavior). The output of the HTGT can be used to detect anomalies or sudden behavioral deviations with high temporal granularity. This enables cross-modal risk reasoning (e.g., suspicious topic + negative tone + late-night interactions).

In regard to collecting real time activity data from node communications 402, embodiments herein may collect data from all types of communications sources, such as but not limited to, social media activity, messaging apps (text, chat logs), browsing patterns, gaming consoles, or in-app voice/video/audio cues. In regard to constructing a Heterogeneous Temporal Interaction Graph (HTIG) 404, the nodes may be users, apps, topics, messages, content types of diverse protocols. The edges are modeled interactions (e.g., DM, voice chat, friend request). The edge attributes may be gathered to include time, sentiment, topic, content type, and the like. In this way the network graph evolves dynamically as new interactions occur. The method continues by embedding, into neural network vectors, selected feature data 406 that can be gleaned from the communications that network participants. The feature data may be gathered by attaching node and edge features using processes including but not limited to natural language processing. In this regard, the feature data may extract motion, intent, or topic from texts. Feature data collection may also utilize audio analysis to detect tone changes, stress, fear or computer vision for tracking visual content from shared images or video.

At 410 in FIG. 4, the method of this disclosure applies a real-time risk assessment to trigger alerts after identifying the context of a target node and related communications. The system generates risk scores for ongoing interactions and sends context-aware alerts to guardians (e.g., “suspicious new contact on 2 apps, rising message volume, negative sentiment”). This can trigger educational nudges or pause interaction prompts for the teen, as discussed in more detail below.

FIG. 3 illustrates the example of an HTGT that may be trained for use with an interaction graph (HTIG) to assess risk in communication on a communications network. It is a worthy aside here to note that gaining access to data and/or content on a network may be achieved with permission of network service providers or even with permission of end users. Hardware and software, such as network sniffers, are available to sample communications data for content that is being transmitted and shared on the physical infrastructure provided by network service providers. This kind of permission to access content can be used along with privacy control policies that are inherent in the operations described herein. In fact, even bad actors may be made aware of network service provider policies on the kinds of communications that are considered to be banned from passage on telecommunications infrastructure. All stakeholders in network use, therefore, are well aware of the need for controls in terms of illicit conduct online.

Operations in this disclosure can be described generally in terms of the HTGT of FIG. 3. Physical infrastructure used for network data traffic may be referred to as a communications network herein, and the communications network may be modeled as a graphical network, e.g., a Heterogeneous Temporal Interaction Graph or HTIG. On the HTIG, the communications network may be modeled with users, and their diverse communications applications running on a computer, as “nodes” 302, 306A, 306B connected by edges 304A, 304B. The edges represent transmission media, including but not limited to wired or wireless communications infrastructure of all kinds. In the example of FIG. 3, a given computer user (an individual or an AI user) and/or a respective computer application (e.g., social media, email, chat, telephone, video chats, and the like) maybe considered a target node 302 that is being monitored to ensure that other network participants (also individuals or AI users) are refraining from any kind of illicit, dangerous, or risky communications. Other participants on the network may be considered source nodes 306A, 306B connected to the target node 302 by edges 304A, 304B. As shown in FIG. 3, an HTGT is an excellent tool for contextualizing and assessing diverse kinds of nodes originating from different types of users sharing different kinds of online content. The HTGT is designed to account for such heterogeneous input sources that can all be sampled and/or reformatted into vectors 308A, 308B, 308C that predict a next context from prior data.

Significantly, the HTGT 300 of FIG. 3 applies heterogeneous mutual attention computer 310 made up of a plurality of individual self-attention computer components (e.g., software sections, applications, or modules) that use additional AI tools to incorporate rich feature data and content data into vectors 312, 314 used in the HTGT. In non-limiting embodiments, the HTGT allows for the target node 302 data (e.g., content data and feature data at the target node 302) to be used as a query (Q) that can be compared to source node 304A, 304B data (again, respective content data and respective feature data at a source node). The source nodes for comparison are often referred to as keys with respect to the query data from the target node. Other nodes (e.g., participating computers on the communications network) within a selected environment of the target node can be used to manage message handling 315 that incorporates sampled content and embedded feature data into the HTGT assessment. In some examples, the HTGT uses scaling factors 316A to compute the attention scores that are often probabilities between 0 and 1 that can also serve as weights. The weights can then be used to determine which source node content data and feature data, compiled into value vectors 316B, are used or relied on most heavily in a final aggregation step 318. The HTGT provides insight into each target node’s context relative to its neighboring source nodes (or even remote source nodes) and edges between the two. This contextualized aggregation output 320 can then be assessed for next steps. In the context of this disclosure, the next steps may include output data assessments that determine if the target node is in risky communications environment and from whom that risky communication initiates.

In summary, FIGS. 3 and 4 allow for a computer such as a monitoring computer implementing an HTGT 300 to analyze evolving interaction data between points on a communications network. The monitoring computer leverages a Heterogeneous Temporal Graph Transformer (HTGT). This model employs transformer-based self-attention mechanisms that capture both temporal dependencies and the semantics of different node and edge types. It incorporates time encoding layers to model the timing and sequence of interactions and uses multi-head attention to distinguish and learn from heterogeneous structures across social media, messaging platforms, and multimedia exchanges. HTGT enables the monitoring computer to use respective computer program products to learn behavioral patterns across diverse node types, detect shifts in communication patterns such as manipulative behavior, and flag anomalies with high temporal resolution. It allows for contextual understanding of interactions—for example, when a suspicious topic arises late at night with an increasingly negative emotional tone across multiple platforms. These capabilities equip embodiments of this disclosure to predict potential escalation and provide timely alerts or interventions. Feature enrichment is performed using natural language processing (NLP) for emotion and intent detection, audio analysis to recognize stress or fear, and computer vision to monitor shared media such as video data.

A Temporal Graph Neural Network (TGNN), employing architectures like GATs and DyRep, is trained to identify patterns of risky versus normal behavior, predict escalations, and detect behavioral anomalies. Risk scores are generated in real time, triggering context-sensitive alerts to guardians and offering educational nudges or interactive prompts to teens. Ethics and compliance are foundational, with adherence to industry standards. The system supports parental controls, opt-in configurations, and employs differential privacy or federated learning to limit exposure of sensitive data.

As a central focus of ongoing work, we are tackling the more complex and evolving challenge of detecting subtle and indirect harms that traditional content moderation often overlooks. Our research is advancing continual machine learning methodologies that specifically address catastrophic forgetting, ensuring our models maintain long-term contextual understanding. This disclosure enables developing sophisticated transformer-based sequential models integrated with anomaly detection techniques. These models can adapt to new data streams in real-time, continuously learning and identifying nuanced, longitudinal patterns indicative of deceptive behaviors or indirect risks to children. This ongoing effort represents a critical step toward proactive and intelligent safety systems. To effectively interpret situations where children may struggle to clearly express themselves, this disclosure promotes building a hybrid analytical framework that combines fuzzy logic with Bayesian inference. This enables the system to handle ambiguity and uncertainty in behavioral signals, supporting robust risk prediction even with incomplete or fragmented data. The model is further enhanced by large language models, sentiment analysis, and emotional analytics, delivering proactive insights that flag potential concerns arising from unclear or emotionally charged expressions.

Ensuring fairness, transparency, and explainability remains a foundational principle in our system design. This disclosure promotes fairness through the use of diverse, representative datasets and fairness aware algorithms, including adversarial debiasing and fairness constraints. Explainable AI (XAI) tools, such as SHAP and LIME, are embedded to allow stakeholders to interpret model decisions clearly. Our approach is reinforced by continuous auditing and feedback mechanisms to detect, monitor, and correct biases, ensuring sustained trust and accountability in real-world deployment.

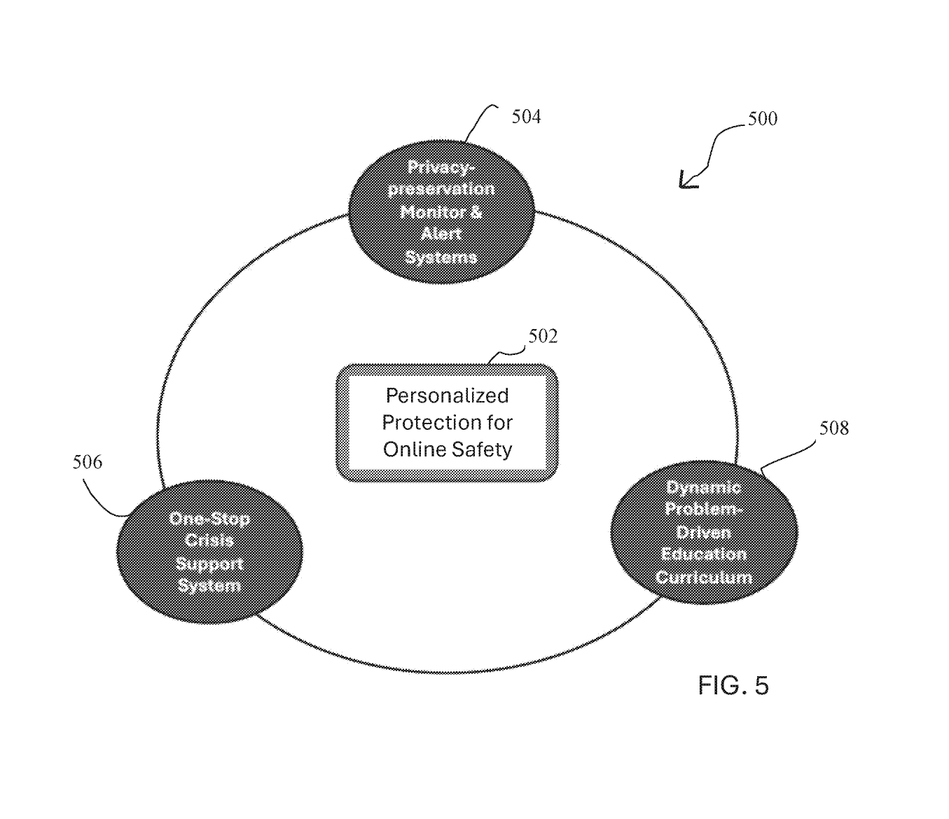

FIG. 5 illustrates how the contextualization 500 of target node environments and source node activity along edges of a graphical network may be used for personalized protection for online safety 502. The contextualized aggregation output 320 may be used to activate a one-stop crisis support system 506 and/or dynamic problem driven education curriculum opportunities 508. Each component of FIG. 5 communicates through secure APIs and adheres to a privacy-first architecture 504 that protects sensitive user data while enabling real-time decision-making and support.

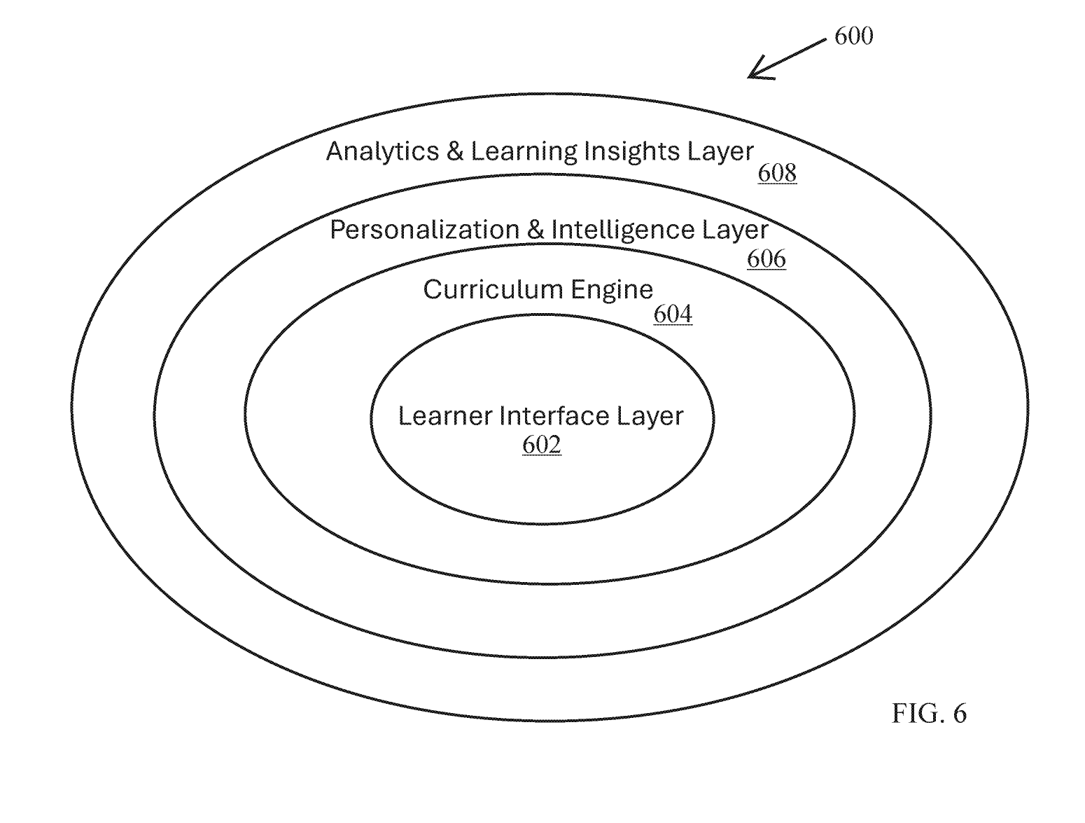

In the diagram of FIG. 6, the HTGT 300 may be considered an example system that can also communicate directly with a user or computer being monitored (e.g., a teen’s phone) to provide educational opportunities in real time based on activities that are actually happening on the network to the user. In example embodiments, a ChatGPT-style tutor that provides immediate educational feedback and explanations regarding risk aversion may be tailored to individual needs. Its curriculum engine is built on a dynamic repository containing real-world problem sets developed with industry input from law enforcement, health, and social justice sectors. This includes modular micro-lessons using videos, quizzes, and interactive case studies. Learners engage through a personalized interface that adapts to their pace and comprehension level, presenting scenario-based challenges of increasing complexity. A built-in analytics dashboard visualizes user progress, engagement levels, and mastery over time.

As shown in FIG. 6, to effectively interpret situations where children may struggle to clearly express themselves, this disclosure promotes building a hybrid analytical framework 600 that combines fuzzy logic with Bayesian inference. This enables the system to handle ambiguity and uncertainty in behavioral signals, supporting robust risk prediction even with incomplete or fragmented data. The model is further enhanced by large language models, sentiment analysis, and emotional analytics, delivering proactive insights that flag potential concerns arising from unclear or emotionally charged expressions. At a learner interface layer 602, a user of a monitored computer may embark on a personalized learner journey with real-world scenario prompts and problem-based challenges with adaptive difficulty. The curriculum engine 604 may include a dynamic content repository, a real-world problem databases (e.g., law enforcement data, health data, and/or social justice data). The curriculum can include industry co-designed case libraries and modular micro-lessons (videos, articles, quizzes) that teach teens in ways that are most effective to them. As noted above, the personalization and intelligence layer 606 may also utilize a ChatGPT-style Tutor Ai that provides just in time hints, explanation or feedback. Finally, the educational components of a system described herein may include a dynamic problem driven education curriculum with an analytics and learning insights layer 608 that may include a student progress dashboard that visualizes growth, time-on-task, and engagement.

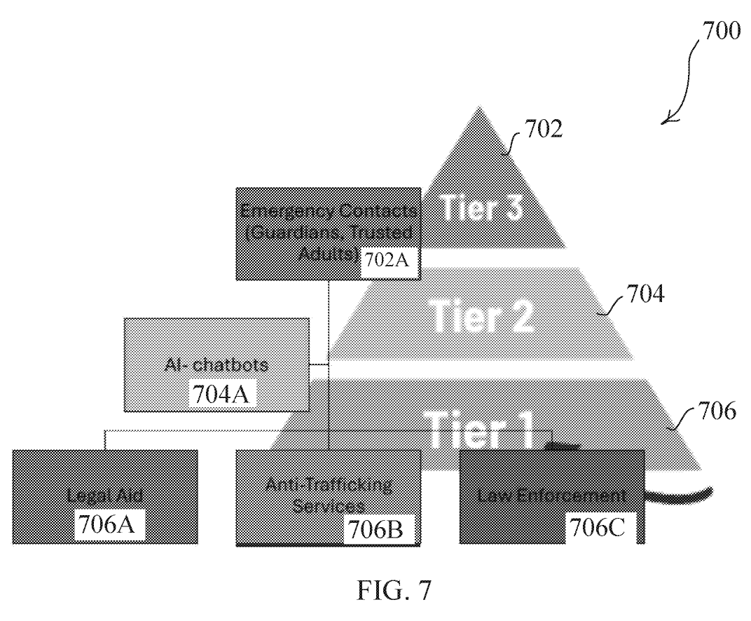

As set forth herein, this disclosure may use aggregated data output from the HTGT 300 to trigger not only educational opportunities for a user, but it can also trigger a crisis response hub sequence 700 as shown in FIG. 7. The crisis response module 700 operates on a three-tier system. Tier 1 706 addresses low-risk situations with educational prompts and chatbot guidance. The prompts may include links to legal aid 706A, anti-trafficking services 706B, and law enforcement 706C. Tier 2 704 handles moderate risks through live chats with counselors and automated parental alerts, such as services provided by AI chatbots. Tier 3 702 is reserved for high-risk cases requiring immediate escalation to emergency services, law enforcement, and comprehensive guardian notifications 702A. The system ensures timely and appropriate intervention based on real-time risk assessment.

Embodiments of this disclosure include a computer-implemented method of monitoring online activities and the method may include placing a monitoring computer in data communication on a network, the monitoring computer having a processor connected to computer memory storing risk monitoring software for use on the network; using the monitoring computer to identify a plurality of communications among participating computers on the network, wherein the participating computers communicate by implementing diverse computer applications; using the monitoring computer, constructing and storing a heterogeneous temporal interaction graph (HTIG) representing the communications among the diverse computer applications on the network; assessing risk associated with respective communications among the diverse computer applications by applying the heterogeneous temporal interaction graph (HTIG) to a trained heterogeneous temporal graph transformer (HTGT); and using the trained HTGT, aggregating contextual information about the diverse computer applications and the respective communications to assign a risk score to communication patterns corresponding to respective diverse computer applications.

In another embodiment, constructing and storing the HTIG comprises assigning the participating computers and/or the diverse computer applications as nodes and assigning network connections between the nodes as edges within the HTIG.

In another embodiment, the nodes in the HTIG are further identified in the computer memory by user identifications, network addresses, application names, message types, and content types.

In another embodiment, the edges in the HTIG are further identified in the computer memory by types of interactions between the nodes, wherein the types of interactions comprise at least one of direct messages, shared voice data, solicited application connections, friend requests, online messenger functions, chatbots, or communications data packet types.

In another embodiment, aggregating contextual information further comprises storing, in the computer memory, meta data regarding the edges for use by the HTGT, the meta data comprising time stamps and additional feature data regarding paired nodes connected by respective edges.

In another embodiment, constructing and storing a heterogeneous temporal interaction graph (HTIG) further comprises modeling the paired nodes as target nodes for contextualizing communications therefrom and source nodes connected to the target nodes.

In another embodiment, the additional feature data corresponding to edges of the HGIT comprises communication time ranges, communication sentiment, communication topic, and communication content type for each edge.

In another embodiment, the method includes enriching the additional feature data of the edges with natural language processing data extracting emotion, intent, or topic from the respective communications.

In another embodiment, enriching the additional feature data is completed by adding to the computer memory audio analysis data corresponding to detected tone of speech, changes in tones of speech, indicators of stress, or indicators of fear in the respective communications.

In another embodiment, the method further includes enriching the feature data by adding to the computer memory computer vision data that tracks visual content within the respective communications.

In another embodiment, the method further includes assigning the participating computers and/or the diverse computer applications as nodes within the HTIG; assigning network connections between the nodes as edges within the HTIG; and for at least one target node connected on the network to at least one source node, using the trained HTGT to perform steps comprising determining weights to model respective communications of the target node relative to the edges connecting the target node and source nodes; and using the weights in the HGTG to identify patterns of communications across diverse node types to indicate a risk of escalation to a corresponding participating computer.

In another embodiment, the method includes using the HGTG of the monitoring computer to identify the patterns of communications as shifting kinds of conversations, behavioral deviations, or combinations of risk factors in the communications.

In another embodiment, the method includes assessing the risk score to trigger alerts sent to participating computers.

In another embodiment, the method includes triggering educational inputs to the participating computers.

In a computer program product for monitoring online activities, another embodiment includes a non-transitory computer readable medium storing instructions thereon that implement components of a heterogeneous temporal graph transformer (HTGT) having multi-head attention software components comprising a plurality of self-attention software components that determine significance of respective types of source nodes of a network graph relative to a target node, wherein the target node is a monitored user node that may be at risk of receiving detrimental communications from respective source nodes communicating with the target node via respective edges of the network graph, wherein the multi-head attention software components implement attention weight parameter vectors for applying to the HTGT for respective source nodes and to designate significance of the source node for inclusion in a risk analysis for the target node. The product further includes time encoding software components that model timing and sequences of interactions among nodes of the network as feature values of the source nodes and heterogeneous message passing components that incorporate meta data regarding the respective edges and source node content into a value vector for use by the HTGT, wherein the HTGT applies the weight parameter vectors from the multi-head attention software components to the value vectors prior to aggregating a contextualized representation for each node in the network.

In another embodiment, the computer program product includes the attention weight parameter vectors and the value vectors being calculated for each type of edge in the network.

The computer program product may include a self-attention software components capture temporal dependencies and interactions between types of nodes.

The computer program product may be configured wherein the multi-head attention software components model heterogenous semantics among communications on the network.

The computer program product may be configured wherein the HTGT generates risk scores for ongoing interactions between nodes.

The computer program product evaluates the risk scores for sending context-aware alerts regarding the target node being monitored and/or triggers educational content provided to the target node being monitored.

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. The patentable scope of certain embodiments of the disclosed technology is indicated by the appended claims, rather than the foregoing description.

1. A computer-implemented method of monitoring online activities, the method comprising:
placing a monitoring computer in data communication on a network, the monitoring computer having a processor connected to computer memory storing risk monitoring software for use on the network;
using the monitoring computer to identify a plurality of communications among participating computers on the network, wherein the participating computers communicate by implementing diverse computer applications;
using the monitoring computer, constructing and storing a heterogeneous temporal interaction graph (HTIG) representing the communications among the diverse computer applications on the network; and
assessing risk associated with respective communications among the diverse computer applications by applying the heterogeneous temporal interaction graph (HTIG) to a trained heterogeneous temporal graph transformer (HTGT); and
using the trained HTGT, aggregating contextual information about the diverse computer applications and the respective communications to assign a risk score to communication patterns corresponding to respective diverse computer applications.

2. The method of claim 1, wherein constructing and storing the HTIG comprises assigning the participating computers and/or the diverse computer applications as nodes and assigning network connections between the nodes as edges within the HTIG.

3. The method of claim 2, wherein the nodes in the HTIG are further identified in the computer memory by user identifications, network addresses, application names, message types, and content types.

4. The method of claim 2, wherein the edges in the HTIG are further identified in the computer memory by types of interactions between the nodes, wherein the types of interactions comprise at least one of direct messages, shared voice data, solicited application connections, friend requests, online messenger functions, chatbots, or communications data packet types.

5. The method of claim 4, wherein aggregating contextual information further comprises storing, in the computer memory, meta data regarding the edges for use by the HTGT, the meta data comprising time stamps and additional feature data regarding paired nodes connected by respective edges.

6. The method of claim 5, wherein constructing and storing a heterogeneous temporal interaction graph (HTIG) further comprises modeling the paired nodes as target nodes for contextualizing communications therefrom and source nodes connected to the target nodes.

7. The method of claim 5, wherein the additional feature data corresponding to edges of the HGIT comprises communication time ranges, communication sentiment, communication topic, and communication content type for each edge.

8. The method of claim 7, further comprising enriching the additional feature data of the edges with natural language processing data extracting emotion, intent, or topic from the respective communications.

9. The method of claim 8, further comprising enriching the additional feature data by adding to the computer memory audio analysis data corresponding to detected tone of speech, changes in tones of speech, indicators of stress, or indicators of fear in the respective communications.

10. The method of claim 9, further comprising enriching the feature data by adding to the computer memory computer vision data that tracks visual content within the respective communications.

11. The method of claim 1, further comprising:
assigning the participating computers and/or the diverse computer applications as nodes within the HTIG;
assigning network connections between the nodes as edges within the HTIG; and
for at least one target node connected on the network to at least one source node, using the trained HTGT to perform steps comprising:
determining weights to model respective communications of the target node relative to the edges connecting the target node and source nodes; and
using the weights in the HGTG to identify patterns of communications across diverse node types to indicate a risk of escalation to a corresponding participating computer.

12. The method of claim 11, further comprising using the HGTG of the monitoring computer to identify the patterns of communications as shifting kinds of conversations, behavioral deviations, or combinations of risk factors in the communications.

13. The method of claim 1, further comprising assessing the risk score to trigger alerts sent to participating computers.

14. The method of claim 1, further comprising triggering educational inputs to the participating computers.

15. A computer program product for monitoring online activities, comprising:
a non-transitory computer readable medium storing instructions thereon that implement components of a heterogeneous temporal graph transformer (HTGT) comprising:
multi-head attention software components comprising a plurality of self-attention software components that determine significance of respective types of source nodes of a network graph relative to a target node, wherein the target node is a monitored user node that may be at risk of receiving detrimental communications from respective source nodes communicating with the target node via respective edges of the network graph;
wherein the multi-head attention software components implement attention weight parameter vectors for applying to the HTGT for respective source nodes and to designate significance of the source node for inclusion in a risk analysis for the target node;
time encoding software components that model timing and sequences of interactions among nodes of the network as feature values of the source nodes;
heterogeneous message passing components that incorporate meta data regarding the respective edges and source node content into a value vector for use by the HTGT,
wherein the HTGT applies the weight parameter vectors from the multi-head attention software components to the value vectors prior to aggregating a contextualized representation for each node in the network.

16. The computer program product according to claim 15, wherein the attention weight parameter vectors and the value vectors are calculated for each type of edge in the network.

17. The computer program product according to claim 15, wherein the self-attention software components capture temporal dependencies and interactions between types of nodes.

18. The computer program product according to claim 17, wherein the multi-head attention software components model heterogenous semantics among communications on the network.

19. The computer program product according to claim 15, wherein the HTGT generates risk scores for ongoing interactions between nodes.

20. The computer program product according to claim 19, wherein the computer program product evaluates the risk scores for sending context-aware alerts regarding the target node being monitored and/or triggers educational content provided to the target node being monitored.
